(19) United States
(12) Patent Application Publication
(10) Pub. No.: US 2012/0146934 A1
(43) Pub. Date: Jun. 14, 2012

(54) Event Registration and Dispatch System and Method for Multi-Point Controls

(75) Inventor: Philip L. Davidson, New York, NY (US)

(73) Assignee: PERCEPTIVE PIXEL INC., New York, NY (US)

(21) Appl. No.: 13/399,694

(22) Filed: Feb. 17, 2012

Related U.S. Application Data
(62) Division of application No. 12/432,563, filed on Apr. 29, 2009.
(60) Provisional application No. 61/048,713, filed on Apr. 29, 2008.

(51) Int. Cl. G06F 3/041

(52) U.S. Cl. 345/173; 178/18.03

(57) ABSTRACT

Dynamic registration of event handlers in a computer application or operating system recognizes multiple synchronous input streams by identifying each new stroke in a frame representing a single moment in time and mapping in a registration process each identified new stroke to a listening process that is associated with the user interface element to which the new input stream is to be applied. In the same frame, released strokes are unmapped and then each active listening process is called to carry out a respective control operation. When called, the strokes have the correct data for the given frame. The process is repeated for subsequent frames. By carrying out various processes in a sequence of frames, the concept of concurrency is preserved, which is particularly beneficial to multi-touch and multi-user systems.

### REFERENCE TO RELATED APPLICATION

This application is a divisional application of U.S. application Ser. No. 12/432,563, filed Apr. 29, 2009, and claims priority to U.S. provisional patent application No. 61/048,713, filed Apr. 29, 2008, the disclosures of which are incorporated herein by reference.

### BACKGROUND OF THE INVENTION

1. Field of the Invention

The present invention is a novel method for dynamic registration of event handlers in a computer application or operating system that recognizes multiple synchronous input streams, such as those produced from multi-point or multi-touch input devices. The inventive registration and event dispatch system fundamentally preserves the notion of concurrent event delivery and is applied in a system-wide manner. This is particularly advantageous for interfaces that allow multiple simultaneous users.

2. Description of the Related Art

The delivery of user input data, generally in the form of a discrete sequence of events, is a core component of any user interface (UI) model. Common UI models, such as Windows, Java AWT/Swing, SDL, manage event delivery by dispatching a continuous series of update events to a set of input handlers. This generally takes the form of a queue of generic messages containing input such as key events, mouse motions, and mouse-button clicks, in addition to alternative devices such as tablets. This is sufficient for single user applications, where the windowing system can dispatch this common event stream to an appropriate foreground context, because it is assumed that there is a singular point of application focus and control. For example, keyboard events will be dispatched to the last text window selected in a word processor, and mouse events will be dispatched to the window that is underneath the current mouse pointer. This model may be extended to support multiple control devices assigned to pre-defined functions. As an example, a 3d modeling application might use a six-axis control device to set view orientation while employing the mouse to edit an object in the scene, and switch to keyboard controls to change tool modes.

The use of sequential event model and input stream frequently breaks down when the set of active input event streams changes frequently in response to a non-traditional application environment, such as a multi-point or multi-touch device, where there is no single “foreground window” or “focus window” and within each foreground or focus window, no single “active input field” (i.e., focus) or “pointer location” structure to direct the input stream. In addition, it may be possible that multiple users are working concurrently. Accordingly, the event streams must be mapped dynamically to a collection of applications and their subcomponents, each of which may be actively responding to multiple contact points. Even when multiple event streams may be properly identified and assigned to specific application functions, it may be arbitrary or erroneous to perform independent updates based on these streams.

### OBJECTS AND SUMMARY OF THE INVENTION

In view of the foregoing, it is an object of the present invention to provide an event registration and dispatch model appropriate for various control environments, such as in multi-touch and multi-user systems.

To achieve the foregoing and other objects, a method of handling input streams representing strokes on a multi-point input device capable of having multiple synchronous input streams is provided that comprises the steps of: identifying each new stroke in a given frame and mapping each identified new stroke to one or more listening processes, the given frame representing a single moment in time; identifying each released stroke in the given frame and unmapping each identified released stroke from the respective listening process to which the stroke previously was mapped; implementing in the given frame each listening process to which at least one stroke is mapped, each implemented listening process being carried out based on a current state of each stroke mapped to the respective listening process; and repeating both identifying steps and implementing step for each of a successive plurality of frames.

As an aspect of the present invention, each listening process is associated with a user interface element that includes an associated “tangible” that dynamically determines whether the new stroke is to be mapped to the respective listening process.

As a feature of this aspect, each identified new stroke is mapped based on a positional relationship between a point of contact on the multi-point input device of the identified new stroke and the tangibles of the user interface elements.

As a further aspect of the present invention, each listening process to which at least one stroke is mapped is implemented based on a current position of contact of each stroke mapped to the respective listening process.

As another aspect of the present invention, an identified new stroke is mapped to a listening process to which another stroke already is mapped; and the listening process to which a plurality of strokes are mapped is implemented based on current states of the plural strokes mapped to the respective listening process.

As an additional aspect of the present invention, an identified new stroke can be mapped to a plurality of listening processes.

As yet a further aspect of the present invention, the mapping step comprises ascertaining at least one of a plurality of user interface elements to which an identified new stroke is applicable; and mapping the identified new stroke to a listener process associated with the ascertained user interface element.

As a feature of this aspect, the user interface elements have a hierarchical structure; and the ascertaining step employs the hierarchical structure by assessing user interface elements higher in the hierarchical structure before assessing user interface elements lower in the hierarchical structure.

As yet another aspect of the present invention, a first stroke represents a contact of the multi-point input device, and identifying each new stroke comprises identifying a new second stroke in a given frame before the first stroke is released, and the first and second strokes are made by two different people.

In accordance with the present invention, a method of handling input streams in a multi-point input device capable of having multiple synchronous input streams comprises the steps of: maintaining a list of one or more user interface elements that respond to contact of the multi-point input device, each of the user interface elements having an associated tangible and at least one associated listener, each listener representing a respective control operation; processing, for each given frame of a plurality of frames each representing a single moment in time, one or more input streams representing contacts of the multi-point input device by: identifying each new stroke in the given frame, a new stroke representing a new contact of the multi-point input device; registering each identified new stroke to the listener of at least one of the user interface elements in the maintained list based on a relationship between a position of contact of the identified new stroke and the tangible of one or more interface elements; notifying, for each listener to which a new stroke has been registered in the given frame, the respective listener of the existence of the respective new stroke, each notified listener representing an active listener; identifying each released stroke in the given frame, a released stroke representing an end of a contact of the multi-point input device; notifying, for each identified released stroke in the given frame, the respective listener of the discontinuation of the released stroke, each active listener being notified of only released strokes becoming an inactive listener; and dispatching, in the given frame, each of the active listeners to implement the respective control operation based on an updated state or states of one or more non-released strokes of which the respective listener is notified, the updated state of a non-released stroke corresponding to a current position of contact of the multi-point input device.

For the summarized method in the foregoing paragraph, the above-summarized aspects and features provided also are applicable to such summarized method.

In accordance with a system embodiment of the present invention, a multi-point input system comprises a multi-point input device having an input surface and adapted to sense simultaneous contacts of the input surface and providing as an output data streams representing strokes on the input surface over a period of time; and a controller for receiving the data streams from the multi-point input device, carrying out a set of processes during a given frame representing a single moment in time, and repeating the set of processes for each of a successive plurality of frames over said period of time, the set of processes including: identifying each new stroke in a given frame and mapping each identified new stroke to one or more listening processes; identifying each released stroke in the given frame and unmapping each identified released stroke from the respective listening process to which the stroke previously was mapped; and implementing in the given frame each listening process to which at least one stroke is mapped, each implemented listening process being carried out based on a current state of each stroke mapped to the respective listening process.

Each of the above summarized aspects and features of the previously summarized method embodiment also are applicable to the system embodiment set forth in the foregoing paragraph. In addition to such aspects and features, another aspect of the system embodiment provides that the multi-point input device is adapted to sense simultaneous contacts by different users on the input surface.

As a further aspect of the system embodiment, the multi-point input device includes a display surface distinct from the input surface; and the controller controls the multi-point input device to display on the display surface at least one user interface element, and at least one listening process implemented by the controller modifies an appearance of the user interface element displayed on the display surface.

As another aspect of the system embodiment, the input surface is adapted to operate as a display surface for the multi-point input device; and the controller controls the multi-point input device to display on the display surface at least one user interface element, and at least one listening process implemented by the controller modifies an appearance of the user interface element displayed on the display surface.

In accordance with the present invention, a multi-point input system comprises: a multi-point input device having an input surface and adapted to sense simultaneous contacts of the input surface and providing as an output data streams representing strokes on the input surface over a period of time; and a controller for maintaining a list of one or more user interface elements that respond to contact of the input surface and that have an associated tangible and at least one associated listener representing a respective control operation, receiving the data streams from the multi-point input device, carrying out a set of processes during a given frame representing a single moment in time, and repeating the set of processes for each of a successive plurality of frames over said period of time, the set of processes including: identifying each new stroke in the given frame, a new stroke representing a new contact of the input surface; registering each identified new stroke to the listener of at least one of the user interface elements in the maintained list based on a relationship between a position of contact of the identified new stroke and the tangible of each user interface element; notifying, for each listener to which a new stroke has been registered in the given frame, the respective listener of the existence of the respective new stroke, each notified listener representing an active listener; identifying each released stroke in the given frame, a released stroke representing an end of a contact of the input surface; notifying, for each identified released stroke in the given frame, the respective listener of the discontinuation of the released stroke, each active listener being notified of only released strokes becoming an inactive listener; and dispatching, in the given frame, each of the active listeners to implement the respective control operation based on an updated state or states of one or more non-released strokes of which the respective listener is notified, the updated state of a non-released stroke corresponding to a current position of contact of the input surface.

Each of the foregoing provided aspects and features may also be applied to the system embodiment summarized in the foregoing paragraph.

Additional objects, features, aspects, and advantages of the present invention are discussed below, and other objects, advantages and features will become readily apparent to those of ordinary skill in the art.

### BRIEF DESCRIPTION OF THE DRAWINGS

The following detailed description, given by way of example and not intended to limit the present invention solely thereto, will best be appreciated in conjunction with the accompanying drawings, in which:

FIG. 1 illustrates nine (9) frames used to describe the event registration and dispatch method/system of the present invention;

FIG. 2 schematically shows a time sequence of the stroke events in FIG. 1;

FIGS. 3A through 3D schematically show the progression of placement of a set of control points placed over different keys on the keyboard in accordance with the present invention;

FIG. 4 schematically shows the correlating sequence of dispatch events within each of the frames illustrated in FIG. 3; and

FIGS. 5A-5D schematically illustrate various systems embodying the present invention.

### DETAILED DESCRIPTION OF THE PRESENT INVENTION

As stated above, the present invention is a novel method for dynamic registration of event handlers in a computer application or operating system that recognizes multiple synchronous input streams, such as those produced from multi-point or multi-touch input devices, and/or those in which multiple users may be present. As discussed in further detail below, this registration and event dispatch system fundamentally preserves the notion of concurrent event delivery and is applied in a system-wide manner.

Multi-touch input devices are becoming commercially economical due to advancements in touch sensing technologies, reduction in manufacturing costs, and other factors. U.S. patent application Ser. No. 11/833,908; U.S. patent application Ser. No. 12/185,782; U.S. patent application Ser. No. 12/182,440; U.S. Patent Application 60/821,325; U.S. Patent Application 60/953,966; U.S. Patent Application 60/952,709; U.S. Patent Publication US2008/0029691A1; U.S. Patent Publication US2008/0284925A1; and U.S. Patent Publication No. US2009/0033637A1, all assigned to the assignee of the present application and incorporated herein by reference, describe various multi-touch technologies, including among other things multi-touch sensing through frustrated total internal reflection. U.S. Patent Publication Nos. 2008/0180404A1, 2008/0180405A1 and 2008/0180406A1, also assigned to the assignee of the present invention and incorporated fully herein by reference, describe particular advancements in both 2D and 3D object control and 3D globe view control, among other things.

In the above-identified publications and patent applications, multi-touch display devices/processes are described generally in the context of where the incoming points are assumed to be multiple fingers, although other devices may be employed to contact the input device. For the discussion herein, the following terms are used for convenience and are defined as follows: the term “stroke” represents an input stream; the terms “hit” and “touch” represent the beginning of the input stream; and the terms “lift” and “release” represent the end of the input stream. Each stroke possesses a unique identifier over its total duration. In the herein-described inventive core dispatch system, no a-priori relation is assumed from one stroke to another, except as inferred by higher-level processes specific to the application. Thus, two strokes that follow one another may not be from the same finger, and two simultaneous strokes may not be from the same user.

In accordance with the present invention, the herein-described event registration and dispatch system/method respects the concept of concurrency, which is particularly beneficial in multi-touch, multi-user environments. Also in accordance with the present invention, updates to the input states are delivered as a sequence of “frames,” with each frame representing a single moment in time. The ordering of events within a frame is considered a consequence of sequential transmission and processing, so elements in the system respond in a consistent fashion after all of their inputs have a consistent time-state. Moreover, the frame structure ensures that the dispatch of events for different users do not interrupt or arbitrarily precede one another.

The core of the event dispatch system of the present invention is a dynamic mapping between stroke objects, which represent event streams for a contact point, and event listener processes that respond to incoming stream data (referred to herein as StrokeListener objects/components). The association pattern between streams and listeners is many-to-many: each StrokeListener object may subscribe to several streams simultaneously, and strokes may broadcast data to any number of concurrent listeners. Common UI components, such as a checkbox controller or scrollbar object, may have a single associated listener to handle a range of functionality based on the number of inputs and the state of the input. For example, a scrollbar with two active inputs may allow a change of scale and position, instead of position alone. Complex application objects may be composed of multiple StrokeListener components, each of which performs specific control operations with respect to their associated application context. Each stroke may influence a number of objects at once, even if they are not associated with one another. Listener elements that control many degrees of freedom may use input from several strokes to exert full control over the underlying model.

Initial Registration: In accordance with the present invention, the subscription (and corresponding unsubscription) between strokes and StrokeListeners is managed through a call to the event registration interface. The registration procedure for a new stroke is initiated by a system call that takes place in the first frame that a stroke is detected. The system maintains a list of UI elements that respond when a new input (e.g., touch) is detected, which are referred to as “tangibles.” In the present invention, the input may be something other than physical touch, and thus use of the term “touch” and the like is to be understand to cover other types of inputs as herein mentioned. Moreover, input may also entail other types of hand-tracking interfaces, such as multiple mice pointers and other forms of input including gestures, hand tracking, pointing, or any other non-contact input for which a position is tracked. Each tangible object implements a generic “hit” method, which allows the object to decide whether a particular stroke should be registered to any or all of to its attached controllers, to subscribe any or all of its StrokeListener components to receive regular updates from that stroke, and to set up any necessary contextual information to assign strokes to a particular function. As an example, a StrokeListener controlling a painting program may assign one stroke to move the canvas, while assigning a second stroke to draw lines.

Each time a stroke begins, the event system calls the hit method for each of the root level tangibles to find the initial set of subscribers for the incoming stroke. If a tangible is composed of other tangibles, the element preferably dispatches the method hierarchically on each of its sub-components. This operation terminates when all objects have been tested, or when a tangible returns a value to the system indicating that dispatch should stop. Tangibles may register listener components for a stroke without terminating the callback, so that the stroke may be subscribed to by other elements in the scene. The hit method may be called multiple times over the lifetime of a single stroke if the system determines new tangibles are eligible to be touched by that stroke. Application elements may use the interface registration functions to directly modify listener/subscriber relationships during the interaction.

StrokeListeners: StrokeListeners implement the following three methods to respond to updates from registered strokes: onBegin(Stroke*s); onEnd(Stroke*s); and onFrame( ). onBegin( ) and onEnd( ) are called to notify the listener in the first and last frame of a stroke's existence, and allow the listener object to modify any necessary state for adding or removing a stroke. OnBegin messages are called from the registration interface. Once the onEnd( ) method has been called, the stroke has passed out of the system and should not be referenced.

When a StrokeListener is registered as a subscriber for one or more strokes, it receives an onFrame( ) notification from the event system at the end of each input frame. The onFrame( ) call indicates that all subscribed strokes for that object have been updated. The registration system maintains a set of the active strokes registered to each listener object, The listener object may also maintain its own set of active strokes, along with any contextual information that is associated to them, Once called, the listener object updates any internal state with the knowledge that all strokes have correct data for their frame. Thus, complex state variables can be maintained in a consistent and orderly manner from frame to frame. As an example, an object that is being moved by two strokes, A and B, should only update its position once per frame, when both new locations are known. A sequential update approach would incompletely (and inefficiently) update the location twice per frame.

To the extent possible, the action of these callbacks is idempotent with regard to the order in which listeners are updated relative to other active listeners in the system. The context of an incoming event stream is determined independently by each application component, and preserves the proper parallelism for multi-point, multi-user environments, where one cannot assume that inputs come from the same pointing device or from the same user.

The accompanying figures, described in further detail below, are used to demonstrate system behavior for the registration and event subscription for three strokes on a collection of application objects. The structure of the event dispatch within a frame is as follows:

1. Increment frame counter.

2. For each new stroke, dispatch an initial registration callback through root hit( ) method. This potentially results in registration callbacks, and on StrokeBegin( ) initializations per listener.

3. For each released stroke, dispatch on StrokeEnd( ) calls to all registered listeners.

4. Update state for all new and active strokes,

5. Dispatch onFrame( ) call for the set of active listeners.

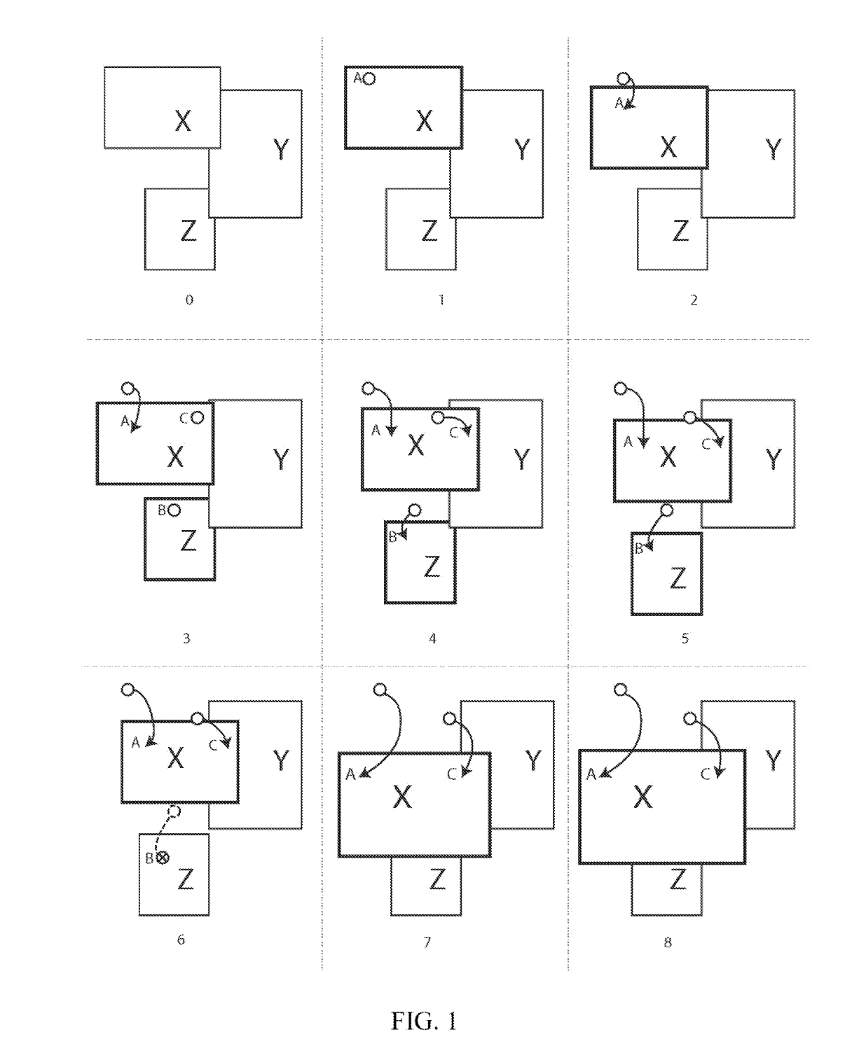

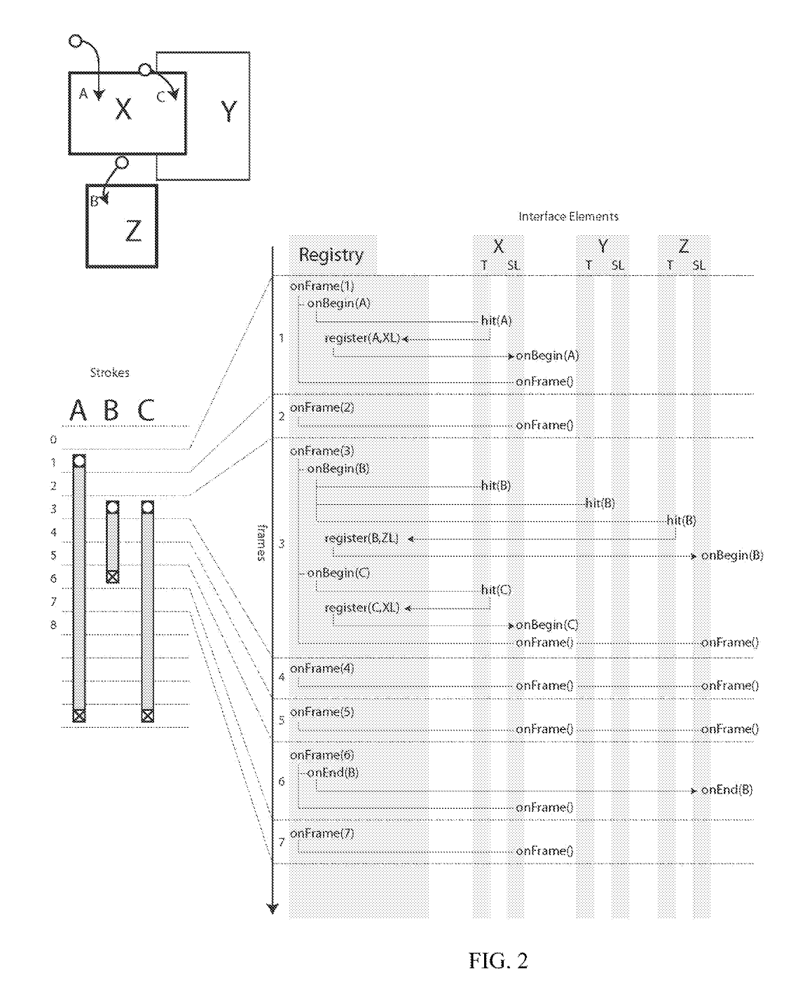

Referring now to the accompanying figures, FIG. 1 schematically illustrates multiple dispatch and registration behavior for three exemplary UI elements, X, Y, and Z, and a series of exemplary strokes A, B and C over a set of 9 input frames. Each element contains a tangible (T) component representing its spatial extent, and a StrokeListener (SL) component that moves and resizes the element. FIG. 2 schematically shows a time sequence of the stroke events in FIG. 1, and provides a more detailed breakdown of the registration and update calls that are generated within the event system as strokes are started and released in parallel. In the example provided, components with active subscriptions are shown with a bold outline in the figures.

Referring to illustrative FIGS. 1 and 2, registration and dispatch in accordance with the present invention operate as follows: Frame 0 represents an initial state of the system, during which elements X, Y, Z are at rest. In Frame 1, stroke A begins, at which point: (a) X's tangible is called for stroke A, which succeeds, registering A with its listener element, and ends the registration dispatch; (b) X's listener receives onBegin( ) call for A; and (c) onFrame( ) method is dispatched for X's stroke listener.

In Frame 2, A is moved, at which point onFrame( ) is dispatched for X's listener, adjusting its position.

In Frame 3, strokes 13 and C begin, at which point: (a) B checks unsuccessfully against tangibles X and Y, but is successful for tangible Z; (b) Z's listener receives onBegin( ) for B; (c) Stroke C tests successfully against X, and ends dispatch; (d) A's listener receives onBegin( ) for C; and (e) The listeners of X and Z receive frame events( ). X's position and size are now determined by both A and C.

In Frame 4, A, B and C are updated, wherein the listeners of X and Z receive frame events( ). X and Z's positions, as well as X's size, are recalculated.

In Frame 5, A, B and C are updated. The listeners of X and Z receive frame events( ). X and Z's positions and X's size are again recalculated.

In Frame 6, A and C continue, and B is released, wherein B's only subscriber, Z, is notified that the stroke has ended through onEnd( ), and the association is cleared from the registry. The listener of X receives frame events( ). X's position and size are recalculated.

In Frames 7, 8, A and C are updated, wherein X's listener receives frame events( ). X's position and size are recalculated.

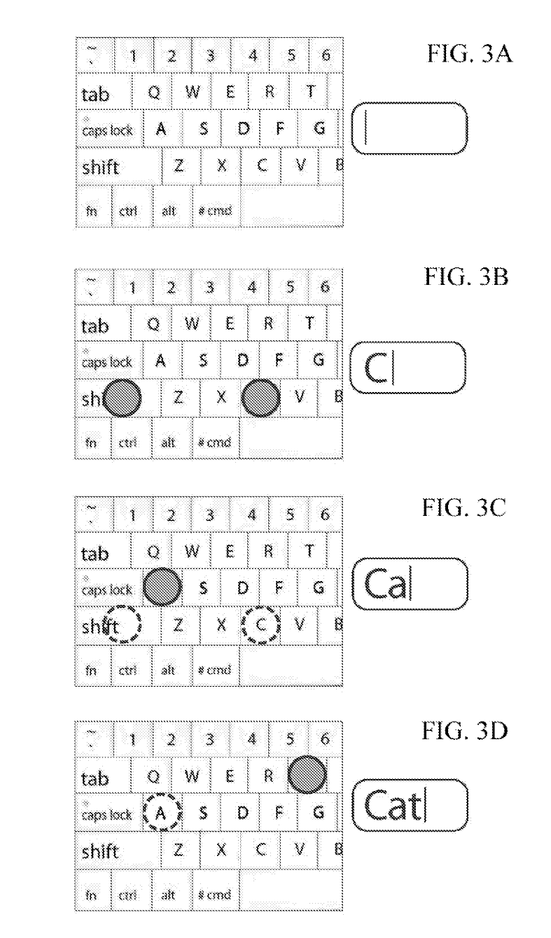

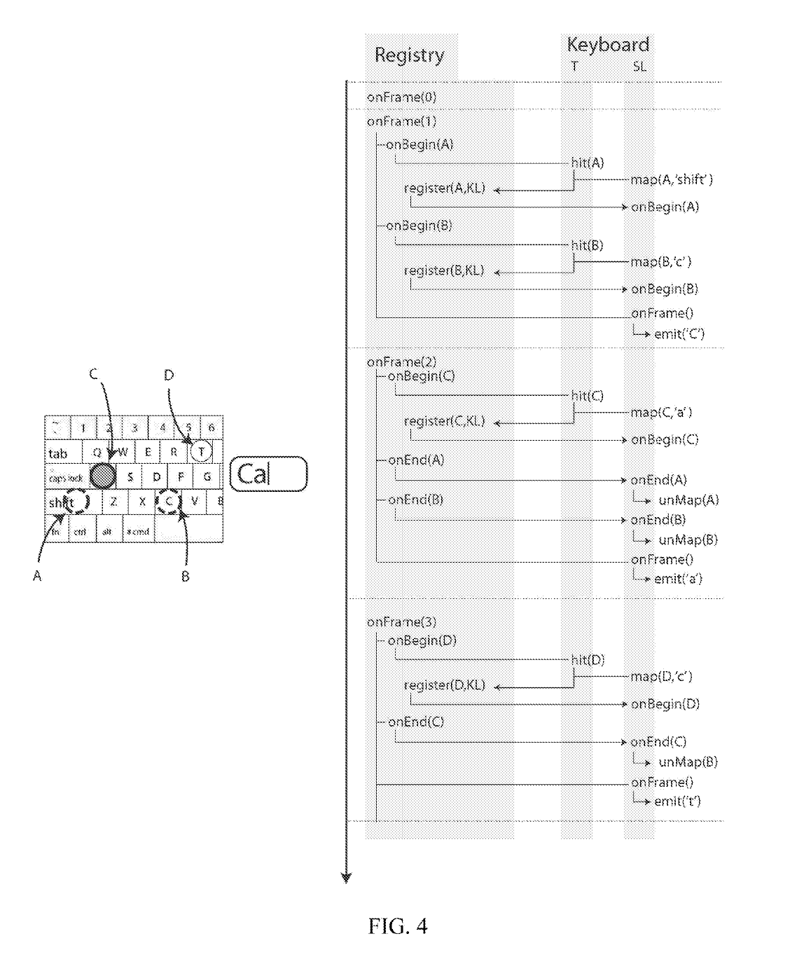

FIGS. 3A-3D and 4 represent application of the present invention to an exemplary typing operation on a multi-touch keyboard element. FIG. 3A through 3D schematically show the progression of placement of a set of control points placed over different keys on the keyboard. FIG. 4 schematically shows the correlating sequence of dispatch events within each of the illustrated frames.

FIG. 3A shows an initial Frame 0, before the occurrence of a stroke. FIG. 3B shows Frame 1, in which strokes A and B are set down on the “c” and “shift” keys, respectively. In frame 1, hit( ) calls are made for strokes A and B. The keyboard object maps stroke A to the “c” key and stroke B to the “shift” key, and registers as a listener. onBegin(A) is sent to the listener, marking “c” as a new key-press. onFrame is called for the keyboard application. The shift key is down, and “c” is a new press, so a capital ‘C’ is emitted.

FIG. 3B shows frame 2, in which stroke C starts on key “a”, while strokes A and B are lifted. Stroke C begins. The hit method is dispatched for Stroke C, and mapped to key “a”. An onBegin( ) call is made to the keyboard listener object, marking “a” as a new key-press. Strokes A and B are lifted, so the onEnd(call is dispatched to the listener for both strokes, and the keys are unmapped. onFrame( ) is called on the listener object. “a” is still marked as a new key-press, so a lowercase “a” is emitted.

FIG. 3C shows frame 3, in which stroke C is lifted and stroke D begins. During this frame, a hit method is dispatched for Stroke D. The keyboard's hit( ) function maps D to key “t”. An onBegin call is made to the keyboard's listener for stroke D, and “t” is marked as a new key-press. The onEnd call is dispatched for stroke C, and the key is unmapped. onFrame( ) is called on the keyboard's listener object, and a “t” is emitted.

As illustrated in FIGS. 3 and 4, the onBegin( )/onEnd( )/onFrame structure of the event dispatch maintains a consistent interpretation of the strokes—“Cat,” which is independent of the order in which strokes are ordered within the frame. Without such structure, the order in which key states are activated and/or deactivated within each frame would affect their combined behavior, and could emit several potential letter sequences, such as “CAt,” “cAt,” or “cat,” depending on the order in which events are interpreted, which violates order-independence. By separating the insertion and removal of individual strokes from the combined frame update call, a consistent ordering is maintained, and the application element does not act or propagate responses based on incomplete information

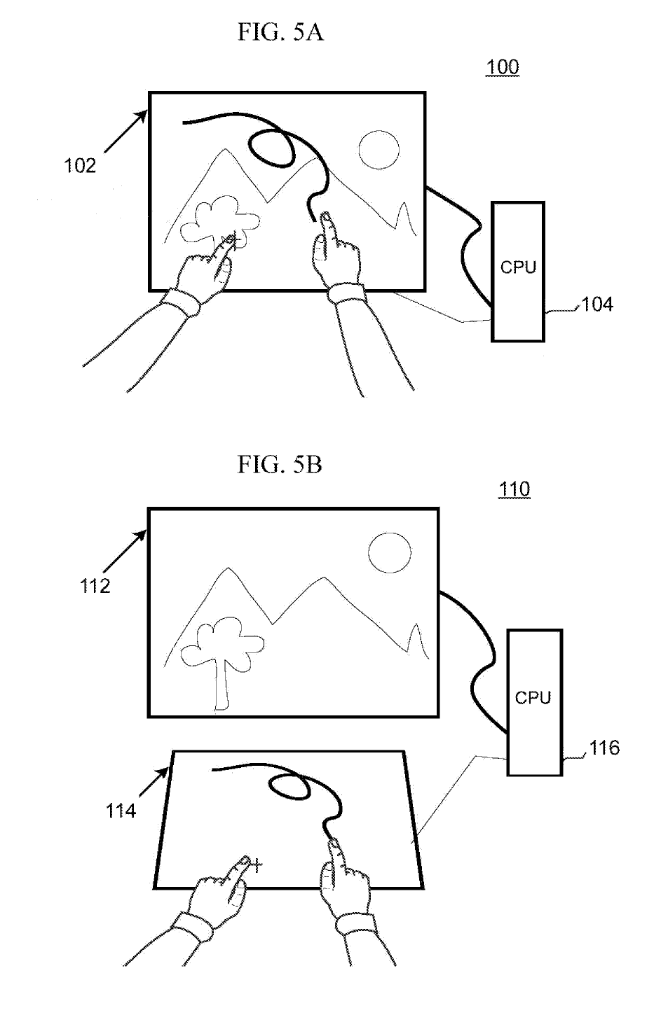

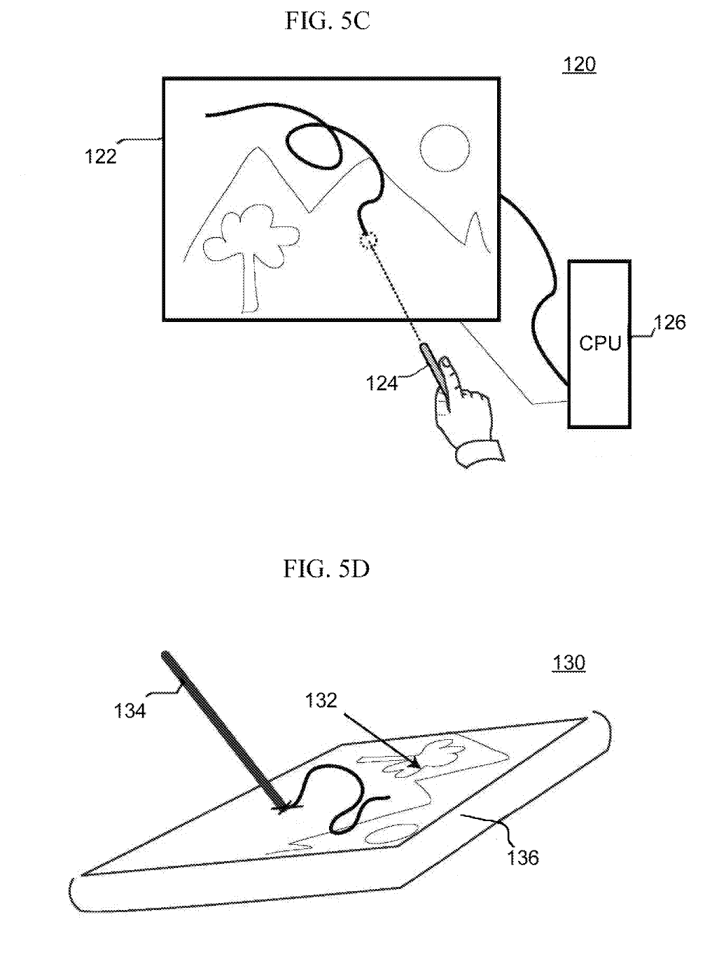

FIGS. 5A-5D schematically illustrate several systems that may embody the present invention. Each system includes a graphical display surface, a device that can detect and track motion (e.g., touchscreen, mouse, trackpad, 3D motion tracker, stylus, laser pointer, gyroscopic pointing device), and a controller capable of receiving input from the pointing device, processing the received input in accordance with the herein-described registration and dispatch, and to provide output to the display surface. As is appreciated, such devices may be embodied or incorporated within a single device or may be separate devices. For example, FIG. 5A is a schematic illustration of a multi-touch system 100 that includes a multi-input display 102 with integrated touch-sensing capability and a separate control system (CPU) 104. FIG. 5B is a schematic illustration of a multi-touch system 110 that includes three distinct devices: a graphical display 112, a touch sensor 114, and a controller 116. FIG. 5C shows yet another system 120 that may be employed and that includes graphical display 122 with an integrated pointing system that employs a laser pointing device 124, along with a processor 126. As yet another example, FIG. 5D shows a completely integrated system 130 that contains a graphical surface 132, a pointing device 134, and a controller 136. Pointing device 134 may be a user's finger. Other variations of systems may be employed in accordance with the present invention. Controllers suitable for use in each of the systems mentioned above are well known, and it is within the ability of one of ordinary skill in the art to design and/or program a controller to implement the methods, processes, techniques and features of the present invention, given the description provided herein.

The present invention has been described as set forth above. It is to be understood, however, that other expedients known to those skilled in the art may be employed without departing from the spirit of the invention.

What is claimed is:

1. A multi-point input system, comprising:
a multi-point input device having an input surface and adapted to sense simultaneous contacts of the input surface and providing as an output data streams representing strokes on the input surface over a period of time; and
a controller configured to maintain-a set of one or more user interface elements that respond to contact of the input surface and that have an associated tangible and at least one associated listener representing a respective control operation, receive the data streams from the multi-point input device, carry out a set of processes during a given frame representing a single moment in time, and repeat the set of processes for each of a successive plurality of frames over said period of time, the set of processes including:
identifying each new stroke in the given frame, a new stroke representing a new contact of the input surface;
registering each identified new stroke to the listener of at least one of the user interface elements in the maintained set based on a relationship between a position of contact of the identified new stroke and the tangible of one or more of the user interface elements;
notifying, for each listener to which a new stroke has been registered in the given frame, the respective listener of the existence of the respective new stroke, each notified listener representing an active listener;
identifying each released stroke in the given frame, a released stroke representing an end of a contact of the input surface;
notifying, for each identified released stroke in the given frame, the respective listener of the discontinuation of the released stroke, each active listener becoming an inactive listener conditioned on being notified of released strokes such that the listener is no longer listening to any strokes; and
dispatching, in the given frame, each of the active listeners to implement the respective control operation based on an updated state or states of one or more non-released strokes of which the respective listener is notified, the updated state of a non-released stroke corresponding to a current position of contact of the input surface.

2. The system of claim 1,
wherein the controller being configured to carry out the registering process comprises the controller being configured to register an identified new stroke to a listener to which a non-released stroke is already registered; and
wherein the controller being configured to carry out the dispatching process comprises the controller being configured to implement the respective control operation corresponding to said listener to which a plurality of non-released strokes are registered based on the updated states of said plurality of non-released strokes.

3. The system of claim 1, wherein the controller being configured to carry out the registering process comprises the controller being configured to register an identified new stroke to a plurality of listeners.

4. The system of claim 1, wherein the controller being configured to carry out the registering process comprises the controller being configured to ascertain at least one of the user interface elements to which the identified new stroke is applicable, and register the identified new stroke to the listener of the ascertained user interface element.

5. The system of claim 4, wherein the user interface elements in the set have a hierarchical structure; and the controller is configured to ascertain at least one of the user interface elements to which the identified new stroke is applicable using the hierarchical structure by assessing user interface elements higher in the hierarchical structure before assessing user interface elements lower in the hierarchical structure.

6. The system of claim 1,
wherein a first stroke represents a contact of the input surface by a first person, and
wherein the controller being configured to carry out the identifying each new stroke process comprises the controller being configured to identify a second stroke in the given frame that represents a new contact of the input surface by a second person, and
wherein the first stroke is a non-released stroke in the given frame.
